(19) United States
(12) Patent Application Publication
(10) Pub. No.: US 2026/0285601 A1
(43) Pub. Date: Sep. 24, 2026

(54) MOVEMENT CONTROL SYSTEM, MOVEMENT CONTROL METHOD, AND MOVEMENT CONTROL PROGRAM

(71) Applicant: MITSUBISHI HEAVY INDUSTRIES, LTD., Tokyo (JP)

(72) Inventors: Kenji TAKAO, Tokyo (JP); Yusuke HAZUI, Tokyo (JP)

(73) Assignee: MITSUBISHI HEAVY INDUSTRIES, LTD., Tokyo (JP)

(21) Appl. No.: 19/474,648

(22) PCT Filed: Feb. 6, 2024
(86) PCT No.: PCT/JP2024/003859

§ 371 Date: Oct. 10, 2025

(30) Foreign Application Priority Data
Apr. 18, 2023 (JP) 2023-067964

(51) Int. Cl. B65G 1/137; B65G 1/04; B66F 9/06

(52) U.S. Cl. CPC B65G 1/1378; B65G 1/0492; B66F 9/063

(57) ABSTRACT

This movement control system is provided with: a management device that transmits transfer instruction information instructing that a plurality of objects arranged in a first region are to be transferred to a second region which differs from the first region; an information processing device that, on the basis of the transfer instruction information, generates and transmits first designation information for designating the position of a conveyance destination in a relay region provided between the first region and the second region for each of the plurality of objects positioned in the first region, and second designation information for designating the position of a conveyance destination in the second region for each of the objects arranged in the relay region; and a control device for controlling a plurality of moving bodies that move autonomously and can convey the object on the basis of the first designation information and the second designation information.

### DESCRIPTION

### Technical Field

The present disclosure relates to a movement control system, a movement control method, and a movement control program.

Background Art

Moving bodies that move automatically to transport objects such as cargo are known. For example, PTL 1 describes a transport system in which an unmanned transport vehicle transports cargo between a plurality of conveyors.

### CITATION LIST

### Patent Literature

[PTL 1] Japanese Patent No. 5729606

### SUMMARY OF INVENTION

### Technical Problem

In a movement control system for controlling such a moving body, efficient transport of a plurality of objects is required.

The present disclosure has been made in consideration of the above circumstance, and an object of the present disclosure is to provide a movement control system, a movement control method, and a movement control program capable of efficiently transporting a plurality of objects.

### Solution to Problem

A movement control system according to the present disclosure includes a management device that transmits transfer instruction information for instructing transfer of a plurality of objects to be disposed in a first region to a second region different from the first region, an information processing device that generates and transmits first designation information for designating a position in a relay region, which is a transport destination, for each of the plurality of objects to be disposed in the first region, and second designation information for designating a position in the second region, which is a transport destination, for each of objects to be disposed in the relay region, based on the transfer instruction information, and a control device that controls a plurality of moving bodies capable of moving automatically and transporting the object, based on the first designation information and the second designation information.

A movement control method according to the present disclosure includes a step of transmitting transfer instruction information for instructing transfer of a plurality of objects to be disposed in a first region to a second region different from the first region, a step of generating and transmitting first designation information for designating a position in a relay region, which is a transport destination, for each of the plurality of objects to be disposed in the first region, and second designation information for designating a position in the second region, which is a transport destination, for each of objects to be disposed in the relay region, based on the transfer instruction information, and a step of controlling a plurality of moving bodies capable of moving automatically and transporting the object, based on the first designation information and the second designation information.

A movement control program according to the present disclosure causes a computer to execute a step of transmitting transfer instruction information for instructing transfer of a plurality of objects to be disposed in a first region to a second region different from the first region, a step of generating and transmitting first designation information for designating a position in a relay region, which is a transport destination, for each of the plurality of objects to be disposed in the first region, and second designation information for designating a position in the second region, which is a transport destination, for each of objects to be disposed in the relay region, based on the transfer instruction information, and a step of controlling a plurality of moving bodies capable of moving automatically and transporting the object, based on the first designation information and the second designation information.

### Advantageous Effects of Invention

According to the present disclosure, a plurality of objects can be transported efficiently.

### BRIEF DESCRIPTION OF DRAWINGS

FIG. 1 is a schematic diagram of a movement control system according to the present embodiment.

FIG. 2 is a schematic diagram of a configuration of a moving body.

FIG. 3 is a schematic block diagram of a management device.

FIG. 4 is a schematic block diagram of an information processing device.

FIG. 5 is a schematic block diagram of a control device of the moving body.

FIG. 6 is a diagram showing an example of transfer instruction information.

FIG. 7 is a diagram showing an example of first designation information.

FIG. 8 is a diagram showing an example of second designation information.

FIG. 9 is a diagram showing an example of schedule information.

FIG. 10 is a diagram showing an example of a case in which designation information is updated.

FIG. 11 is a flowchart showing an example of an operation of the movement control system according to the present embodiment.

FIG. 12 is a diagram showing another example of a work region.

### DESCRIPTION OF EMBODIMENTS

Preferred embodiments of the present disclosure will be described in detail below with reference to the accompanying drawings. Note that the present disclosure is not limited to the embodiments, and when there are a plurality of embodiments, the present disclosure also includes configurations in which the respective embodiments are combined.

### Movement Control System

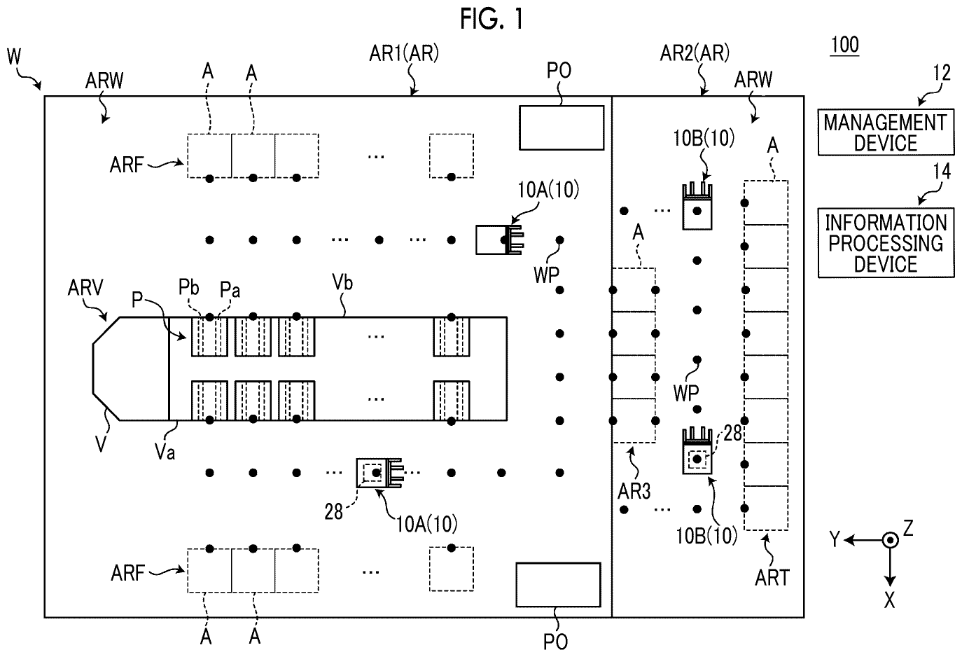

FIG. 1 is a schematic diagram of a movement control system according to the present embodiment. As shown in FIG. 1, a movement control system 100 according to the present embodiment includes a moving body 10, a management device 12, and an information processing device 14. The movement control system 100 is a system that controls movement of the moving body 10 belonging to a facility W. The facility W is, for example, a facility that is subject to logistics management, such as a warehouse, but may be any facility that operates the moving body 10. In the movement control system 100, the moving body 10 picks up an object P disposed within the facility W, transports the object P, and drops the object P at another location. Examples of the object P disposed in the facility W include an object P loaded on a transport vehicle V parked in a parking region ARV in the facility W, which will be described later. In the present embodiment, the object P transported by the moving body 10 is a transport target object with cargo loaded on a pallet. Note that the object P is not limited to a transport target object with cargo loaded on the pallet, and may be in any form. For example, the object may be only the cargo without the pallet. In addition, the moving body 10 is not limited to a moving body that transports the object P, and may be a device that moves in the facility W for any purpose.

### Work Region

As shown in FIG. 1, a work region AR is set in the facility W. The work region AR is a region where the moving body 10 of the present embodiment performs predetermined work such as loading and unloading work. The work region AR includes a loading/unloading region (first region) AR1 and a transfer region (second region) AR2.

The loading/unloading region AR1 is a region where the moving body 10 is deployed. The moving body 10 is capable of moving within the loading/unloading region AR1. However, the moving body 10 may not be able to move throughout the entire loading/unloading region AR1, and may be unable to move, for example, in a parking region ARV to be described later or in regions where the object P and a fixed object PO (such as pillars or walls within the facility W) are located. In the following description, one direction along the loading/unloading region AR1 is defined as an X direction, and a direction along the loading/unloading region AR1 that intersects with the direction X is defined as a Y direction. In the present embodiment, the Y direction is a direction orthogonal to the X direction. The X direction and the Y direction may be referred to as directions along a horizontal plane. In the X direction and the Y direction, a direction of an arrow is indicated as a + direction (or + side), and a direction opposite to the + direction is indicated as a − direction (or − side). In addition, a direction orthogonal to the X direction and the Y direction, more specifically, a direction toward an upper side in a vertical direction, is referred to as a Z direction. In addition, in the present embodiment, unless otherwise specified, “position” refers to a position (coordinates) in a coordinate system on a two-dimensional surface of the loading/unloading region AR1 (the coordinate system of the loading/unloading region AR1). In addition, the term “posture (orientation)” of the moving body 10 or the like refers to an orientation of the moving body 10 or the like in the coordinate system of the loading/unloading region AR1, and indicates a yaw angle (rotation angle) of the moving body 10 when the X direction is set to 0° in a case in which the moving body 10 or the like is viewed in the Z direction, unless otherwise specified.

The loading/unloading region AR1 is a so-called truck berth, and includes a parking region ARV where a transport vehicle V is parked, and a movement region ARW in which the moving body 10 can move. The parking region ARV is a region for parking the transport vehicle V, and the movement region ARW is a region of the loading/unloading region AR1 other than the parking region ARV. It is preferable that the transport vehicle V is parked in a predetermined position and posture relative to the parking region ARV. The transport vehicle V is a moving body that transports the loaded object P between the inside and outside of the facility W. For example, the transport vehicle V arrives at the facility W with an object P loaded thereon and is stopped in the parking region ARV, and the loaded object P is then carried out by the moving body 10. In addition, an object P may be loaded by the moving body 10 onto the transport vehicle V stopped in the parking region ARV. In the present embodiment, the transport vehicle V is a truck, but is not limited thereto and may be any moving body that transports the object P, such as a rail vehicle. The transport vehicle V is provided with an accommodation chamber Va in which the object P is disposed. In the example of FIG. 1, doors Vb are provided on both sides (the +X side and the −X side) of the transport vehicle V. With the door Vb open, the moving body 10 approaches the accommodation chamber Va from an opening portion (here, a side) of the door Vb of the transport vehicle V, thereby picking up an object P in the accommodation chamber Va or dropping the object P into the accommodation chamber Va. However, the transport vehicle V is not limited to one having the door Vb provided on the side, and the door Vb may be provided at any position of the transport vehicle V (for example, at a rear).

It is preferable that a temporary installation region ARF in which the object P is disposed is also set in the loading/unloading region AR1. The temporary installation region ARF is set in a partial region within the movement region ARW. In the example of the present embodiment, since the temporary installation region ARF is at the same height as the movement region ARW, the moving body 10 can enter the temporary installation region ARF where the object P is not disposed. However, the present disclosure is not limited to the above, and the moving body 10 may not be able to enter the temporary installation region ARF. In the example of FIG. 1, the loading/unloading region AR1 is set on the X direction side and an opposite side to the X direction of the parking region ARV within the loading/unloading region AR1. However, the position and the number of the temporary installation regions ARF are arbitrary, and they may be provided at any position separate from the parking region ARV. In the present embodiment, the temporary installation region ARF is a temporary placement area for the object P. That is, for example, depending on the operation status of the facility W, an object P loaded on the transport vehicle V or an object P scheduled to be loaded on the transport vehicle V may be temporarily placed in the temporary installation region ARF. The object P temporarily placed in the temporary installation region ARF is transported to another location (for example, the transport vehicle V or a transfer region AR2 to be described later). However, the purpose of the transfer region AR2 is not limited to a temporary placement area. The transfer region AR2 may be a region for any purpose in which the object P is placed.

The temporary installation region ARF includes a plurality of unit regions A. The unit region A is a region set for disposing the object P, and can be said to be a region where the object P is likely to be installed. The shape and the size of the unit region A are set in advance. In the example of FIG. 1, the unit region A is rectangular, but the shape and the size thereof may be arbitrary. Moreover, the unit region A is partitioned for each object P, and one object P is disposed in each unit region A. In each unit region A, depending on the status of the facility W, there is a case in which the object P is disposed and a case in which the object P is not disposed. In the example of FIG. 1, the unit regions A are set to be aligned in the Y direction in the temporary installation region ARF, but the alignment and the number of the unit regions A in the temporary installation region ARF may be arbitrary.

In the loading/unloading region AR1, although there is one parking region ARV in the example of FIG. 1, there may be a plurality of parking regions ARV. That is, for example, a plurality of parking regions ARV may be set to be aligned in the X direction. In addition, the loading/unloading region AR1 is not limited to a truck berth including the parking region ARV and the movement region ARW, and may be any region where the moving body 10 moves (performs work).

The transfer region AR2 is provided at a position adjacent to the loading/unloading region AR1 (the movement region ARW). In the example of FIG. 1, the transfer region AR2 is located on the −Y side of the loading/unloading region AR1 (movement region ARW). The transfer region AR2 includes a disposition region ART. The disposition region ART is for disposing the object P. The disposition region ART includes a plurality of unit regions A. The disposition, the shape, and the like of the unit region A are not limited to the example shown in FIG. 1.

In the present embodiment, the moving body 10 in the loading/unloading region AR1 can drop the object P in the transfer region AR2 and pick up the object P disposed in the transfer region AR2, but it is preferable that the moving body 10 does not move in the transfer region AR2. For example, the transfer region AR2 is located on the Z direction side with respect to the loading/unloading region AR1 (that is, is set at a position higher than the loading/unloading region AR1). The moving body 10 is restricted from entering between the loading/unloading region AR1 and the transfer region AR2. In other words, the moving body 10 is restricted from entering the transfer region AR2 from the loading/unloading region AR1. In addition, the moving body 10 is restricted from entering the loading/unloading region AR1 from the transfer region AR2. In addition, the moving body 10 in the loading/unloading region AR1 may be able to enter the transfer region AR2, and the moving body 10 in the transfer region AR2 may be able to enter the loading/unloading region AR1. For example, the loading/unloading region AR1 and the transfer region AR2 may be set at the same height. Hereinafter, when the moving body 10 moving in the loading/unloading region AR1 and the moving body 10 moving in the transfer region AR2 are distinguished from each other, the moving body 10 moving in the loading/unloading region AR1 will be referred to as a first moving body 10A, and the moving body 10 moving in the transfer region AR2 will be referred to as a second moving body 10B.

A relay region AR3 is provided in a part of the transfer region AR2. The relay region AR3 is a region for disposing the object P. In the present embodiment, the relay region AR3 delivers the object P between the loading/unloading region AR1 and the transfer region AR2. The relay region AR3 can be accessed by the moving body 10 from both the loading/unloading region AR1 and the transfer region AR2. The relay region AR3 may be provided between the loading/unloading region AR1 and the transfer region AR2, or may be provided in a part of the loading/unloading region AR1. For example, the moving body 10 in the loading/unloading region AR1 carries the object P picked up from the transport vehicle V or the temporary installation region ARF into the relay region AR3. In addition, the moving body 10 in the loading/unloading region AR1 picks up the object P carried into the relay region AR3, carries the object P out of the relay region AR3, and transports the object P to the transport vehicle V or the temporary installation region ARF. In addition, the moving body 10 in the transfer region AR2 picks up the object P carried into the relay region AR3, carries the object P out of the relay region AR3, and transports the object P to the disposition region ART. In addition, the moving body 10 in the transfer region AR2 carries the object P disposed in the disposition region ART into the relay region AR3. The relay region AR3 is not limited to the delivery of the object P, and may be used for other purposes.

The relay region AR3 includes a plurality of unit regions A. In the example of FIG. 1, the unit regions A are set to be aligned in the X direction in the relay region AR3, but the alignment and the number of the unit regions A in the relay region AR3 may be arbitrary. The relay region AR3 may be provided at a plurality of locations in the work region AR. For example, when a plurality of parking regions ARV are provided to be aligned in the X direction, a configuration may be employed in which the relay region AR3 is provided for each of the parking regions ARV.

### Waypoint

In the work region AR, a waypoint WP is set for each position (coordinates). The movement route of the moving body 10 is set to connect the waypoints WP. That is, a route connecting the waypoints WP through which the moving body 10 is scheduled to pass becomes the movement route of the moving body 10. The waypoints WP are set according to the layout of the work region AR. For example, the waypoints WP may be set in a matrix pattern in the region in which the moving body 10 can move within the work region AR. In addition, the waypoint WP is set in advance according to a position where the object P is disposed in the parking region ARV. In addition, the waypoint WP can be set to correspond to a unit region A or the like in which the object P is disposed in the work region AR. For example, the waypoint WP can be set at a position (coordinates) corresponding to each unit region A.

### Moving Body

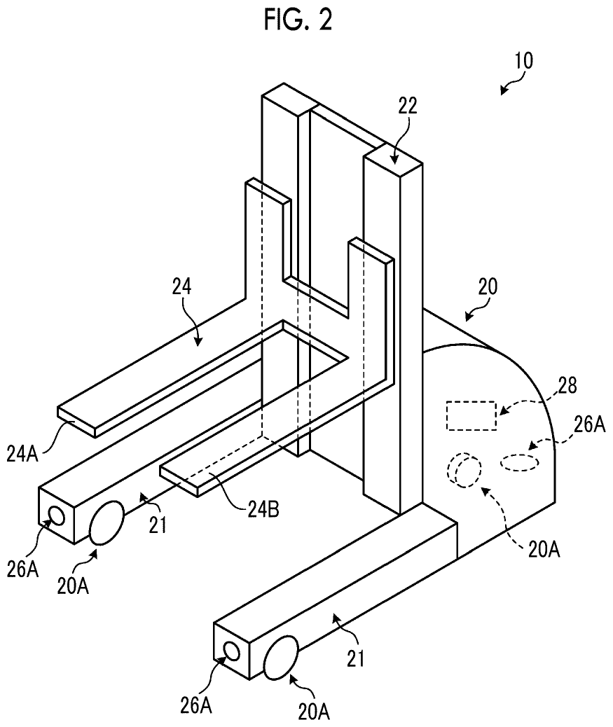

FIG. 2 is a schematic diagram of a configuration of the moving body. The moving body 10 is a device capable of moving automatically. In the present embodiment, the moving body 10 is a non-holonomic system that cannot move directly sideways. The moving body 10 may be configured as a three-wheel drive vehicle with three-wheel steering. Furthermore, the moving body 10 may be configured to be capable of moving directly sideways, or to be capable of pivot turning. In the present embodiment, the moving body 10 is a device capable of transporting a target object. Additionally, in the present embodiment, the moving body 10 is a forklift, and, more specifically, is a so-called automated guided vehicle (AGV) or an automated guided forklift (AGF). However, the moving body 10 is not limited to being a forklift that transports a target object, and may be any device that can move automatically.

As shown in FIG. 2, the moving body 10 includes a vehicle body 20, wheels 20A, straddle legs 21, a mast 22, a fork 24, a sensor 26A, and a control device 28. The straddle legs 21 are a pair of shaft-shaped members provided at one end portion of the vehicle body 20 in a front-rear direction and protruding from the vehicle body 20. The wheels 20A are provided at a tip of each of the straddle legs 21 and on the vehicle body 20. That is, although a total of three wheels 20A are provided, positions and the number of the wheels 20A may be arbitrary. The mast 22 is movably attached to the straddle legs 21 and moves in the front-rear direction of the vehicle body 20. The mast 22 extends along an up-down direction (here, a direction Z) orthogonal to the front-rear direction. The fork 24 is attached to the mast 22 to be movable in the direction Z. The fork 24 may also be movable relative to the mast 22 in a lateral direction (a direction intersecting the up-down direction and the front-rear direction) of the vehicle body 20. The fork 24 has a pair of forks 24A and 24B. The forks 24A and 24B extend from the mast 22 toward a front direction of the vehicle body 20. The fork 24A and the fork 24B are spaced apart from each other in the lateral direction of the mast 22. Hereinafter, in the front-rear direction, a direction on the side on which the fork 24 is provided in the moving body 10 is referred to as a front direction, and a direction on the side on which the fork 24 is not provided is referred to as a rear direction.

The sensor 26A detects at least one of a position and a posture of an object present around the vehicle body 20. It can also be said that the sensor 26A detects at least one of the position of the object with respect to the moving body 10 and the posture of the object with respect to the moving body 10. In the present embodiment, the sensor 26A is provided at the tip of each straddle leg 21 in the front direction and on the rear direction side of the vehicle body 20. Note that a position where the sensor 26A is provided is not limited thereto, and the sensor 26A may be provided at any position, and the number of the sensors 26A provided may also be arbitrary.

The sensor 26A is, for example, a sensor that emits laser light. The sensor 26A emits laser light while performing scanning in one direction (here, the lateral direction) and detects the position and the orientation of the object from reflected light of the emitted laser light. That is, the sensor 26A can also be said to be a so-called two-dimensional (2D)-light detection and ranging (LiDAR) sensor. Here, the sensor 26A is not limited to the above and may be a sensor that detects the object using any method, for example, a so-called three-dimensional (3D)-LiDAR that performs scanning in a plurality of directions, a so-called one-dimensional (1D)-LiDAR that does not perform scanning, or a camera.

The control device 28 controls the movement of the moving body 10. The control device 28 will be described below.

### Management Device

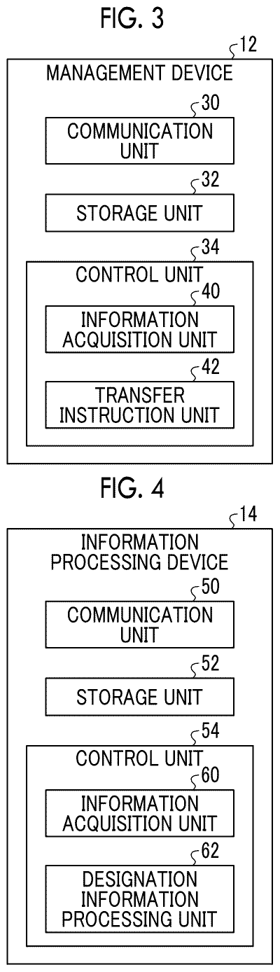

FIG. 3 is a schematic block diagram of the management device. The management device 12 is a system that manages logistics in the facility W. Although the management device 12 is a warehouse control system (WCS) or a warehouse management system (WMS) in the present embodiment, the management device 12 is not limited to a WCS and a WMS and may be any system, for example, a back-end system such as another production management system. A position where the management device 12 is provided is arbitrary, and the management device 12 may be provided in the facility W or may be provided at a position separate from the facility W to manage the facility W from that position. The management device 12 is a computer, and, as shown in FIG. 3, includes a communication unit 30, a storage unit 32, and a control unit 34.

The communication unit 30 is a module used for the control unit 34 and communicating with an external device such as the information processing device 14, and may include, for example, an antenna or the like. A communication method of the communication unit 30 is wireless communication in the present embodiment, but the communication method may be arbitrary. The storage unit 32 is a memory that stores various kinds of information, such as calculation contents of the control unit 34 and programs, and includes, for example, at least one of a main storage device, such as a random-access memory (RAM) or a read-only memory (ROM), and an external storage device, such as a hard disk drive (HDD).

The control unit 34 is a calculation device, and includes, for example, a calculation circuit such as a central processing unit (CPU). The control unit 34 includes an information acquisition unit 40 and a transfer instruction unit 42. The control unit 34 reads out and executes a program (software) from the storage unit 32, thereby realizing the information acquisition unit 40 and the transfer instruction unit 42 and executing the processes thereof. The control unit 34 may execute the processes using one CPU or may include a plurality of CPUs and execute the processes using the plurality of CPUs. Furthermore, at least a part of the information acquisition unit 40 and the transfer instruction unit 42 may be realized by a hardware circuit. In addition, the program for the control unit 34 stored in the storage unit 32 may be stored in a recording medium that can be read by the management device 12.

The information acquisition unit 40 acquires information such as a scheduled arrival time of the transport vehicle V moving toward the facility W, the number of objects P loaded on the transport vehicle V, and the availability of the disposition region ART provided in the transfer region AR2 of the facility W. The transfer instruction unit 42 generates transfer instruction information based on the acquired information and causes the communication unit 30 to transmit the generated transfer instruction information. The transfer instruction information is information for instructing the transfer of the plurality of objects P disposed in the loading/unloading region AR1 to the transfer region AR2. The specific contents thereof will be described below.

### Information Processing Device

FIG. 4 is a schematic block diagram of the information processing device. The information processing device 14 is a device that processes information related to the movement of the moving body 10. The information processing device 14 is, for example, a fleet control system (FCS), but is not limited thereto, and may be any device that processes the information related to the movement of the moving body 10. The information processing device 14 is a computer, and, as shown in FIG. 4, includes a communication unit 50, a storage unit 52, and a control unit 54. The communication unit 50 is a module used for the control unit 54 and communicating with an external device such as the management device 12 and the moving body 10, and may include, for example, an antenna. A communication method of the communication unit 50 is wireless communication in the present embodiment, but the communication method may be arbitrary. The storage unit 52 is a memory that stores various kinds of information, such as calculation contents of the control unit 54 and programs, and includes, for example, at least one of a main storage device, such as a RAM or a ROM, and an external storage device, such as an HDD.

The control unit 54 is a calculation device, and includes, for example, a calculation circuit such as a CPU. The control unit 54 includes an information acquisition unit 60 and a designation information processing unit 62. The control unit 54 reads out and executes a program (software) from the storage unit 52, thereby realizing the information acquisition unit 60 and the designation information processing unit 62 and executing the processes thereof. The control unit 54 may execute the processes using one CPU or may include a plurality of CPUs and execute the processes using the plurality of CPUs. Furthermore, at least a part of the information acquisition unit 60 and the designation information processing unit 62 may be realized by a hardware circuit. In addition, the program for the control unit 54 stored in the storage unit 52 may be stored in a recording medium that can be read by the information processing device 14.

The information acquisition unit 60 acquires the transfer instruction information transmitted from the management device 12. The designation information processing unit 62 generates and updates designation information based on the acquired information. The designation information includes first designation information for designating a position in the relay region AR3, which is a transport destination, for each of the plurality of objects P disposed in the loading/unloading region AR1, and second designation information for designating a position in the transfer region AR2, which is a transport destination, for each of the objects P disposed in the relay region AR3. Specific processing contents thereof will be described below.

In the present embodiment, the management device 12 and the information processing device 14 are separate devices, but may be integrated into one device. That is, the management device 12 may have at least some functions of the information processing device 14, and the information processing device 14 may have at least some functions of the management device 12.

### Control Device of Moving Body

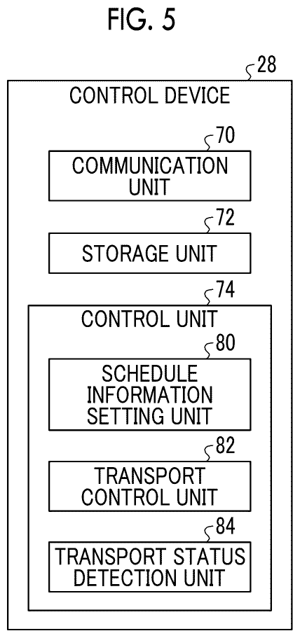

Next, the control device 28 of the moving body 10 will be described. FIG. 5 is a schematic block diagram of the control device of the moving body. The control device 28 is a device that controls the moving body 10. The control device 28 is a computer, and, as shown in FIG. 5, includes a communication unit 70, a storage unit 72, and a control unit 74. The communication unit 70 is a module used for the control unit 74 and communicating with an external device such as the information processing device 14, and may include, for example, an antenna. A communication method of the communication unit 70 is wireless communication in the present embodiment, but the communication method may be arbitrary. The storage unit 72 is a memory that stores various kinds of information, such as calculation contents of the control unit 74 and programs, and includes, for example, at least one of a main storage device, such as a RAM or a ROM, and an external storage device, such as an HDD. The storage unit 72 stores, for example, information about the time required for the operation of the moving body 10, such as the time required for the moving body 10 to perform the operation of picking up one object P, the time required for the moving body 10 to perform the operation of dropping one object P, and the time required for the moving body 10 to move between waypoints WP.

The control unit 74 is a calculation device, and includes, for example, a calculation circuit such as a CPU. The control unit 74 includes a schedule information setting unit 80, a transport control unit 82, and a transport status detection unit 84. The control unit 74 reads out and executes a program (software) from the storage unit 72, thereby realizing the schedule information setting unit 80, the transport control unit 82, and the transport status detection unit 84 and executing the processes thereof. The control unit 74 may execute the processes using one CPU or may include a plurality of CPUs and execute the processes using the plurality of CPUs. Furthermore, at least a part of the schedule information setting unit 80, the transport control unit 82, and the transport status detection unit 84 may be realized by a hardware circuit. In addition, the program for the control unit 74 stored in the storage unit 72 may be stored in a recording medium that can be read by the control device 28.

The schedule information setting unit 80 sets schedule information of the moving body 10, for example, based on information on the time required for the operation of the moving body 10, which is stored in the storage unit 72. The transport control unit 82 controls a movement mechanism of the moving body 10, such as a drive unit or steering, to control the movement of the moving body 10. The transport status detection unit 84 detects a movement status of the object P by the moving body 10 based on an operation history of the moving body 10. The transport status detection unit 84 causes the communication unit 70 to transmit the detected movement status to the information processing device 14. Specific processing contents thereof will be described below.

### Processing of Movement Control System

The processing contents of the movement control system 100 will be described below.

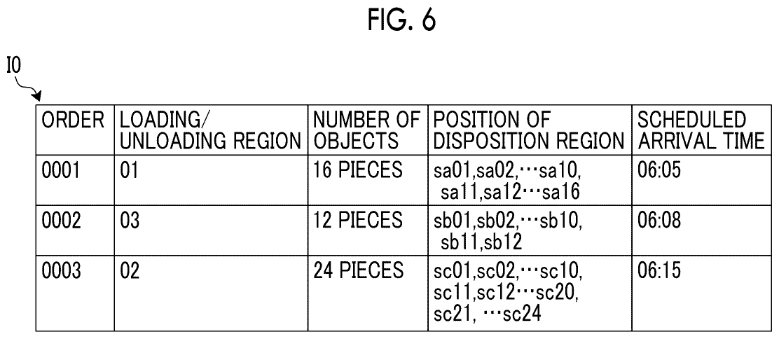

In the management device 12, the information acquisition unit 40 acquires information such as a scheduled arrival time of the transport vehicle V moving toward the facility W, the number of objects P loaded on the transport vehicle V, and the availability of the disposition region ART provided in the transfer region AR2 of the facility W. The transfer instruction unit 42 generates transfer instruction information based on the acquired information. The transfer instruction information is information for instructing the transfer of the plurality of objects P disposed in the loading/unloading region AR1 to the transfer region AR2. FIG. 6 is a diagram showing an example of transfer instruction information I0. As shown in FIG. 6, the transfer instruction information I0 includes, for each transport vehicle V that stops in the loading/unloading region AR1, an order number, a position or identification information of the parking region ARV, a range of the disposition region ART in the transfer region AR2, time information such as the scheduled arrival time of the transport vehicle V, and the like. The transfer instruction unit 42 causes the communication unit 30 to transmit the generated transfer instruction information I0.

In the information processing device 14, the communication unit 50 receives the transfer instruction information I0. The information acquisition unit 60 acquires the received transfer instruction information I0. The designation information processing unit 62 generates designation information for designating the transport destination of the object P, based on the acquired transfer instruction information I0. The designation information includes first designation information for the first moving body 10A moving in the loading/unloading region AR1 and second designation information for the second moving body 10B moving in the transfer region AR2.

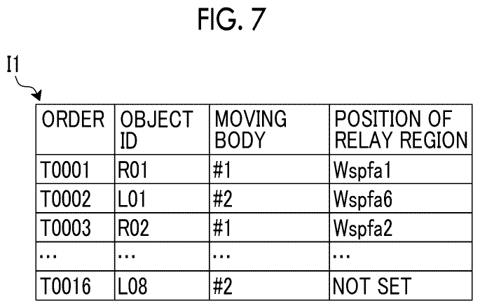

FIG. 7 is a diagram showing an example of first designation information I1. The first designation information I1 is information for designating a position in the relay region AR3, which is a transport destination, for each of the plurality of objects P disposed in the loading/unloading region AR1. As the position in the relay region AR3, which is a transport destination, for example, the position or identification information of each unit region A in the relay region AR3 can be given. Further, the first designation information I1 includes information for designating the moving body 10 that transports the object P for each object P. As shown in FIG. 7, the first designation information I1 includes an order number, identification information of the object P, identification information of the moving body 10 that transports the object P, the position or identification information of the unit region A of the relay region AR3 indicating a transport destination of the object P, and the like.

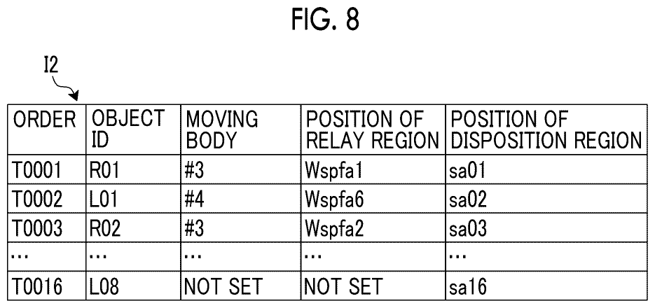

FIG. 8 is a diagram showing an example of second designation information I2. The second designation information I2 is information for designating a position in the transfer region AR2, which is a transport destination, for each of the objects P disposed in the relay region AR3. As the position in the transfer region AR2, which is a transport destination, for example, the position or identification information of each unit region A of the disposition region ART described above can be given. As shown in FIG. 8, the second designation information I2 includes an order number, identification information of the object P, identification information of the moving body 10 that transports the object P, the position or identification information of the unit region A of the relay region AR3 indicating a transport source of the object P, the position or identification information of the unit region A of the disposition region ART indicating a transport destination of the object P, and the like.

Depending on the transport status of the object P by the first moving body 10A and the second moving body 10B, it may be difficult to set which moving body 10 will transport the object P, the transport destination of the object P to be transported by the first moving body 10A and the second moving body 10B, the transport source of the object P to be transported by the second moving body 10B, or the like. In such a case, the designation information processing unit 62 can set an item to be set as “non-set state”, for example, “not set”.

The control device 28 of the moving body 10 controls the operations of the moving body 10 based on the first designation information I1 and the second designation information I2. That is, the control device 28 of the first moving body 10A controls the operations of the first moving body 10A based on the first designation information I1. In addition, the control device 28 of the second moving body 10B controls the operations of the second moving body 10B based on the second designation information I2.

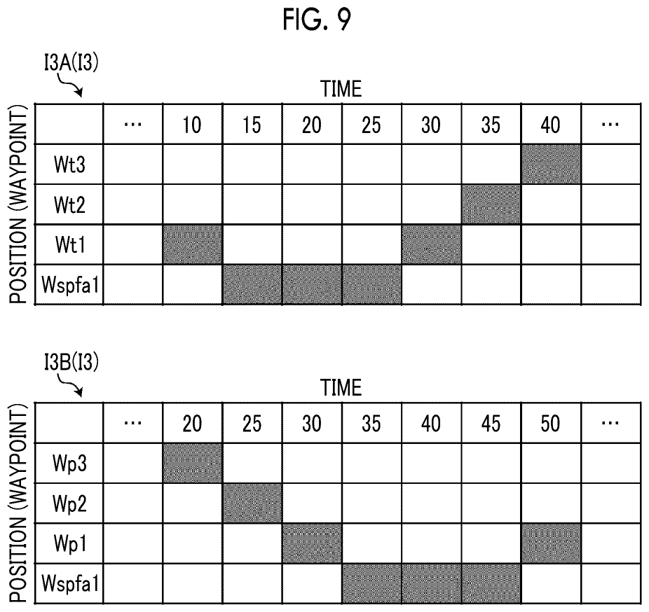

In the control device 28, the schedule information setting unit 80 generates schedule information for designating a timing when the object P is transported to the moving body 10. The transport control unit 82 controls the moving body 10 based on the generated schedule information. FIG. 9 is a diagram showing an example of schedule information I3. As shown in FIG. 9, the schedule information 13 includes first schedule information I3A for the first moving body 10A and second schedule information I3B for the second moving body 10B. In FIG. 9, a horizontal axis represents time.

As shown in FIG. 9, the first schedule information I3A defines a schedule for a series of transport operations of the first moving body 10A, in which the first moving body 10A moves to the transport vehicle V, picks up the object P with the transport vehicle V, moves to the relay region AR3 via a position (waypoint) Wt1, drops the object P in the unit region A of the relay region AR3, and moves again toward the transport vehicle V via positions Wt1, Wt2, Wt3, . . . (omitted thereafter). In the first schedule information I3A shown in FIG. 9, a part of the transport operation of the first moving body 10A is shown. In addition, in FIG. 9, the unit region A at a position Wspfa1 in the relay region AR3 is shown as an example.

In addition, as shown in FIG. 9, the second schedule information I3B defines a schedule for a series of transport operations of the second moving body 10B, for example, in which the second moving body 10B moves to the relay region AR3 via positions Wp3, Wp2, and Wp1, picks up the object P in the unit region A (position Wspfa1) of the relay region AR3, moves to the disposition region ART via positions Wp1, . . . (omitted thereafter), and drops the object P in the unit region A of the disposition region ART. In the second schedule information I3B shown in FIG. 9, a part of the transport operation of the second moving body 10B is shown.

In FIG. 9, in the first schedule information I3A and the second schedule information 13B, for each waypoint WP that the first moving body 10A and the second moving body 10B are scheduled to pass through or stop at, a timing when the first moving body 10A and the second moving body 10B pass through the waypoint WP or a timing when the first moving body 10A and the second moving body 10B stop at the waypoint WP is defined. The first moving body 10A and the second moving body 10B move in the work region AR, and transport the object P based on the control of the transport control unit 82. The transport status detection unit 84 detects the transport status of each moving body 10, and transmits the detection result to the information processing device 14.

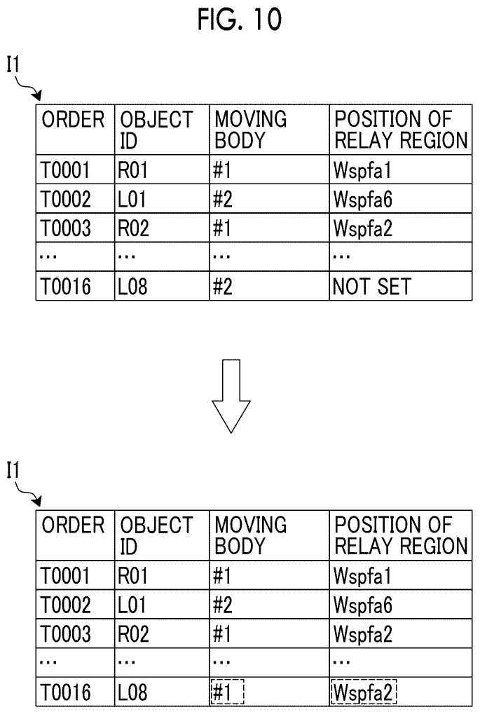

In the information processing device 14, the communication unit 50 receives the transmitted transport status. The information acquisition unit 60 acquires the received transport status. The designation information processing unit 62 detects the transport status of the object P based on the transport status of each moving body 10. The designation information processing unit 62 can update the first designation information I1 and the second designation information I2 according to the transport status of the object P. FIG. 10 is a diagram showing an example of a case in which the designation information is updated. As shown in FIG. 10, the designation information processing unit 62 can appropriately set the setting target items that are not set in the first designation information I1 and the second designation information I2 when the setting target items become settable according to the transport status. In addition, as shown in FIG. 10, the designation information processing unit 62 can also change the settings of the target items set in the first designation information I1 and the second designation information I2 according to the transport status. Accordingly, flexible control can be performed according to the transport status.

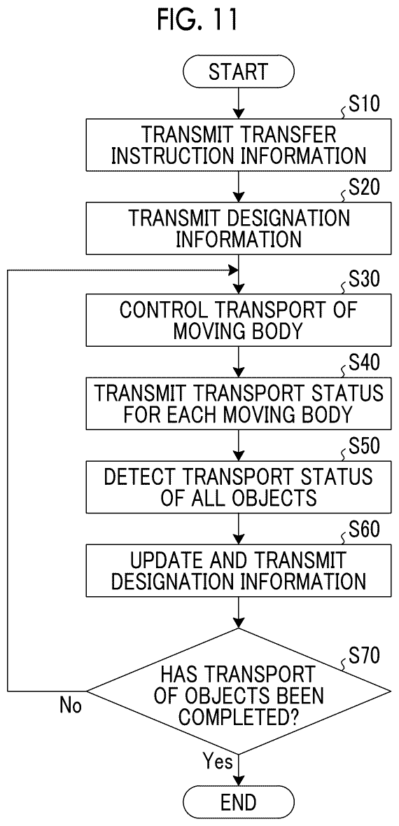

FIG. 11 is a flowchart showing an example of an operation of the movement control system 100 according to the present embodiment. As shown in FIG. 11, in the movement control system 100, the transfer instruction unit 42 of the management device 12 transmits transfer instruction information I0 for instructing the transfer of a plurality of objects P disposed in the loading/unloading region AR1 to a transfer region AR2 different from the loading/unloading region AR1 (step S10).

Next, based on the transfer instruction information I0, the designation information processing unit 62 of the information processing device 14 generates and transmits first designation information I1 for designating a position in the relay region AR3, which is a transport destination, for each of the plurality of objects P disposed in the loading/unloading region AR1, and second designation information I2 for designating a position in the transfer region AR2, which is a transport destination, for each of the objects P disposed in the relay region AR3 (step S20).

Next, the transport control unit 82 of the control device 28 controls the plurality of moving bodies 10 that can automatically move and transport the object P based on the first designation information I1 and the second designation information I2 (step S30). The transport status detection unit 84 detects the transport status of each moving body 10, and transmits the detected result to the information processing device 14 (step S40).

The designation information processing unit 62 of the information processing device 14 detects the transport status of all the objects P based on the transport status of each moving body 10 (step S50). The designation information processing unit 62 updates the first designation information I1 and the second designation information 12 according to the transport status of the object P, and transmits the updated first designation information I1 and second designation information I2 (step S60).

The designation information processing unit 62 determines whether or not the transport of all the objects P has been completed based on the transport status of each moving body 10 (step S70). When it is determined that the transport of all the objects P has not been completed (No in step S70), the process returns to step S30 and the process is performed. When it is determined that the transport of all the objects P has been completed (Yes in step S70), the process is completed.

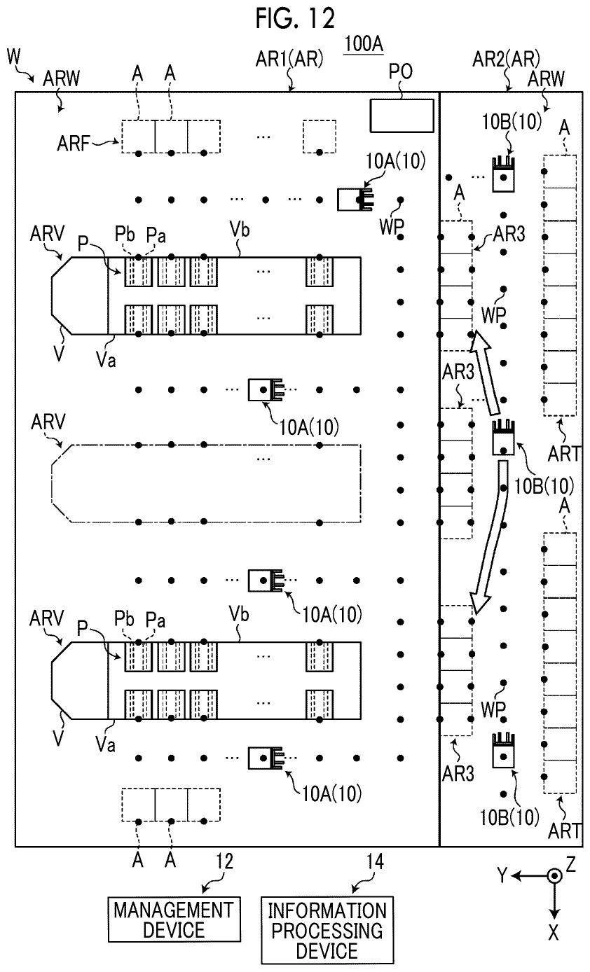

FIG. 12 is a diagram showing another example of the work region AR. In a moving body control system 100A shown in FIG. 12, a plurality of parking regions ARV, for example, three parking regions ARV, are set to be aligned in the X direction in the work region AR. The transfer region AR2 is provided across three parking regions ARV. The relay region AR3 is provided for each parking region ARV. In this case, loading and unloading work is not set up to be performed simultaneously in all three parking regions ARV, but rather, for example, loading and unloading work can be set up to be performed simultaneously only in one parking region ARV in the center in the X direction, or only in two parking regions ARV on both sides in the X direction.

When loading and unloading work is executed simultaneously at two locations on both sides in the X direction, a plurality of first moving bodies 10A, for example, two first moving bodies 10A exclusive to each loading/unloading region AR1, are disposed in each loading/unloading region AR1, that is, a total of four first moving bodies 10A are disposed. Furthermore, three second moving bodies 10B are disposed in the transfer region AR2. Out of the four first moving bodies 10A, for example, first moving bodies 10A disposed second from the top and third from the top in FIG. 12 can be disposed for dual use to correspond to both a relay region AR3 on the +X side and a relay region AR3 on the −X side. First moving bodies 10A disposed at the top and bottom in FIG. 12 may also be disposed for dual use to correspond to both the relay region AR3 on the +X side and the relay region AR3 on the −X side. Out of the three second moving bodies 10B, one can be disposed exclusively to correspond to the relay region AR3 on the +X side, one can be disposed exclusively to correspond to the relay region AR3 on the −X side, and the remaining one can be disposed for dual use to correspond to both the relay region AR3 on the +X side and the relay region AR3 on the −X side.

In this case, in the information processing device 14, the designation information processing unit 62 can generate at least one of the first designation information I1 and the second designation information I2 as information for designating access of at least one moving body 10 (first moving body 10A and second moving body 10B) to the different relay region AR3. Specifically, the designation information processing unit 62 can generate the first designation information I1 as information for designating access of at least one first moving body 10A to the different relay regions AR3. For example, the first designation information I1 for designating an operation of transporting the object P from the transport vehicle V in the parking region ARV to the relay region AR3 on both the +X side and the −X side with respect to the first moving body 10A can be generated. In addition, the designation information processing unit 62 can generate the second designation information I2 as information for designating access of at least one second moving body 10B to the different relay regions AR3. For example, the second designation information I2 for designating the transport of the objects P disposed in the relay regions AR3 on the +X side and the −X side via the second moving body 10B for dual use can be generated. The designation information processing unit 62 can generate or update the first designation information I1 and the second designation information I2 to be preferentially used, of the relay regions AR3 on the +X side and the −X side, on a side where the transport status is congested, for example, according to the transport status of the object P. This operation can improve the transport efficiency of the object P when the loading/unloading regions AR1 on the +X side and the −X side are in operation.

As described above, according to a first aspect of the present disclosure, there is provided a movement control system 100 including a management device 12 that transmits transfer instruction information I0 for instructing transfer of a plurality of objects P to be disposed in a loading/unloading region AR1 to a transfer region AR2 different from the loading/unloading region AR1, an information processing device 14 that generates and transmits first designation information I1 for designating a position in a relay region AR3, which is a transport destination, for each of the plurality of objects P to be disposed in the loading/unloading region AR1, and second designation information I2 for designating a position in the transfer region AR2, which is a transport destination, for each of objects P to be disposed in the relay region AR3, based on the transfer instruction information I0, and a control device 28 that controls a plurality of moving bodies 10 capable of moving automatically and transporting the object P, based on the first designation information I1 and the second designation information I2.

According to this configuration, since the information processing device individually generates the first designation information I1 and the second designation information I2 based on the transfer instruction information I0 and the control device 28 controls the plurality of moving bodies 10 based on the first designation information I1 and the second designation information I2, the object P can be appropriately transported via the relay region AR3. Accordingly, a plurality of objects P can be transported efficiently.

According to a second aspect of the present disclosure, in the movement control system 100 according to the first aspect, the first designation information I1 and the second designation information I2 include information for designating a moving body 10 that transports an object P for each of the objects P. According to this configuration, since the moving body 10 that transports the object P is designated in the first designation information I1 and the second designation information I2, the control device 28 can readily control the moving body 10.

According to a third aspect of the present disclosure, in the movement control system 100 according to the second aspect, the control device 28 generates schedule information for designating, for the moving body 10, a timing at which the moving body 10 transports the object P, and controls the plurality of moving bodies 10 based on the generated schedule information. According to this configuration, it is possible to efficiently control the plurality of moving bodies 10 at a proper timing. For example, in a case where the object P disposed in the unit region A of the relay region AR3 is picked up from one side of the loading/unloading region AR1 and the transfer region AR2, and then the object P is dropped in a newly vacated unit region A after the pick-up on the other side, when a timing deviates slightly, it is determined that “an object P is present at an intended drop place”, and an error occurs. In contrast, according to the present configuration, since the schedule information is set based on the first designation information I1 and the second designation information I2 and the plurality of moving bodies 10 are controlled, it is possible to suppress a deviation in a timing of the operation of the plurality of moving bodies 10.

According to a fourth aspect of the present disclosure, in the movement control system 100 according to any one of the first aspect to the third aspect, the information processing device 14 updates the first designation information I1 and the second designation information I2 according to a transport status of the object P. According to this configuration, flexible control can be performed according to the transport status of the object P.

According to a fifth aspect of the present disclosure, in the movement control system 100 according to the fourth aspect, the control device 28 detects a transport status of each of the moving bodies 10 and transmits the detected transport status to the information processing device 14, and the information processing device 14 detects the transport status of the object P based on the transport status of each of the moving bodies 10. According to this configuration, the transport status of the object P can be accurately detected.

According to a sixth aspect of the present disclosure, in the movement control system 100 according to any one of the first aspect to the fifth aspect, entry of the moving body 10 is restricted between the loading/unloading region AR1 and the transfer region AR2, and the plurality of moving bodies 10 include a plurality of first moving bodies 10 moving in the loading/unloading region AR1 and one or more second moving bodies 10 moving in the transfer region AR2. According to this configuration, it is possible to appropriately perform the transport of the object P via the relay region AR3 in an environment where the entry of the moving body 10 is restricted between the loading/unloading region AR1 and the transfer region AR2.

According to a seventh aspect of the present disclosure, in the movement control system 100 according to the sixth aspect, the relay region AR3 is set at a plurality of locations, and at least one of the first designation information I1 and the second designation information I2 includes information for designating access of at least one of the moving bodies 10 to different relay regions AR3. According to this configuration, when the relay region AR3 is set in a plurality of locations, at least one moving body 10 can access the different relay regions AR3, thereby improving the transport efficiency of the objects P.

According to an eighth aspect of the present disclosure, there is provided a movement control method including a step of transmitting transfer instruction information I0 for instructing transfer of a plurality of objects P to be disposed in a loading/unloading region AR1 to a transfer region AR2 different from the loading/unloading region AR1, a step of generating and transmitting first designation information I1 for designating a position in a relay region AR3, which is a transport destination, for each of the plurality of objects P to be disposed in the loading/unloading region AR1, and second designation information I2 for designating a position in the transfer region AR2, which is a transport destination, for each of objects P to be disposed in the relay region AR3, based on the transfer instruction information I0, and a step of controlling a plurality of moving bodies 10 capable of moving automatically and transporting the object P, based on the first designation information I1 and the second designation information I2. According to this configuration, since the first designation information I1 and the second designation information I2 are individually generated based on the transfer instruction information I0 and the plurality of moving bodies 10 are controlled based on the first designation information I1 and the second designation information I2, the object P can be appropriately transported via the relay region AR3. Accordingly, a plurality of objects P can be transported efficiently.

According to a ninth aspect of the present disclosure, there is provided a movement control program causing a computer to execute a step of transmitting transfer instruction information I0 for instructing transfer of a plurality of objects P to be disposed in a loading/unloading region AR1 to a transfer region AR2 different from the loading/unloading region AR1, a step of generating and transmitting first designation information I1 for designating a position in a relay region AR3, which is a transport destination, for each of the plurality of objects P to be disposed in the loading/unloading region AR1, and second designation information I2 for designating a position in the transfer region AR2, which is a transport destination, for each of objects P to be disposed in the relay region AR3, based on the transfer instruction information I0, and a step of controlling a plurality of moving bodies 10 capable of moving automatically and transporting the object P, based on the first designation information I1 and the second designation information I2. According to this configuration, since the first designation information I1 and the second designation information I2 are individually generated based on the transfer instruction information I0 and the plurality of moving bodies 10 are controlled based on the first designation information I1 and the second designation information I2, the object P can be appropriately transported via the relay region AR3. Accordingly, a plurality of objects P can be transported efficiently.

Although the embodiment of the present disclosure has been described above, the embodiment is not limited by the contents of the embodiment. In addition, the above-described components include those that can be easily assumed by those skilled in the art, those that are substantially the same, and those that are within a so-called equivalent range. Further, the above-described components can be combined as appropriate. Furthermore, various omissions, replacements, or modifications of the above-described components can be made without departing from the concept of the above-described embodiment.

For example, in the above embodiment, a case in which the first region is a loading/unloading region AR1 and the second region is a transfer region AR2, that is, an object P is unloaded from a transport vehicle V stopped in the loading/unloading region AR1 and transferred to the transfer region AR2 of the facility W, has been described as an example, but the present disclosure is not limited to this configuration. For example, a similar description is possible when the first region is a transfer region AR2 and the second region is a loading/unloading region AR1, that is, when an object P disposed in the transfer region AR2 of the facility W is transferred to the loading/unloading region AR1 and loaded onto a transport vehicle V stopped in the loading/unloading region AR1.

### REFERENCE SIGNS LIST

10: moving body
10A: first moving body
10B: second moving body
12: management device
14: information processing device
20: vehicle body
20A: wheel
21: straddle leg
22: mast
24: fork
24A, 24B: fork
26A: sensor
28: control device
30, 50, 70: communication unit
32, 52, 72: storage unit
34, 54, 74: control unit
40, 60: information acquisition unit
42: transfer instruction unit
62: designation information processing unit
80: schedule information setting unit
82: transport control unit
84: transport status detection unit
100, 100A: movement control system
A: unit region
AR: work region
AR1: loading/unloading region
AR2: transfer region
AR3: relay region
ARF: temporary installation region
ART: disposition region
ARV: parking region
ARW: movement region
I0: transfer instruction information
I1: first designation information
I2: second designation information
I3: schedule information
I3A: first schedule information
I3B: second schedule information
P: object
P0: fixed object
V: transport vehicle
Va: accommodation chamber
Vb: door
W: facility
WP: waypoint

1. A movement control system comprising:
a management device that transmits transfer instruction information for instructing transfer of a plurality of objects to be disposed in a first region to a second region different from the first region;
an information processing device that generates and transmits first designation information for designating a position in a relay region, which is a transport destination, for each of the plurality of objects to be disposed in the first region, and second designation information for designating a position in the second region, which is a transport destination, for each of objects to be disposed in the relay region, based on the transfer instruction information; and
a control device that controls a plurality of moving bodies capable of moving automatically and transporting the object, based on the first designation information and the second designation information, wherein
the first designation information and the second designation information include information for designating a moving body that transports an object for each of the objects, and.
the control device generates schedule information for designating, for the moving body, a timing at which the moving body transports the object, and controls the plurality of moving bodies based on the generated schedule information.

2. (canceled)

3. (canceled)

4. The movement control system according to claim 1,
wherein the information processing device updates the first designation information and the second designation information according to a transport status of the object.

5. The movement control system according to claim 4,
wherein the control device detects a transport status of each of the moving bodies and transmits the detected transport status to the information processing device, and
the information processing device detects the transport status of the object based on the transport status of each of the moving bodies.

6. The movement control system according to claim 1,
wherein entry of the moving body is restricted between the first region and the second region, and
the plurality of moving bodies include a plurality of first moving bodies moving in the first region and one or more second moving bodies moving in the second region.

7. The movement control system according to claim 6,
wherein the relay region is set at a plurality of locations, and
at least one of the first designation information and the second designation information includes information for designating access of at least one of the moving bodies to different relay regions.

8. A movement control method comprising:
a step of transmitting transfer instruction information for instructing transfer of a plurality of objects to be disposed in a first region to a second region different from the first region;
a step of generating and transmitting first designation information for designating a position in a relay region, which is a transport destination, for each of the plurality of objects to be disposed in the first region, and second designation information for designating a position in the second region, which is a transport destination, for each of objects to be disposed in the relay region, based on the transfer instruction information; and
a step of controlling a plurality of moving bodies capable of moving automatically and transporting the object, based on the first designation information and the second designation information, wherein
the first designation information and the second designation information include information for designating a moving body that transports an object for each of the objects, and.
the step of controlling the plurality of moving bodies includes generating schedule information for designating, for the moving body, a timing at which the moving body transports the object, and controlling the plurality of moving bodies based on the generated schedule information.

9. A computer-readable recording medium having stored thereon a movement control program causing a computer to execute:
a step of transmitting transfer instruction information for instructing transfer of a plurality of objects to be disposed in a first region to a second region different from the first region;
a step of generating and transmitting first designation information for designating a position in a relay region, which is a transport destination, for each of the plurality of objects to be disposed in the first region, and second designation information for designating a position in the second region, which is a transport destination, for each of objects to be disposed in the relay region, based on the transfer instruction information; and
a step of controlling a plurality of moving bodies capable of moving automatically and transporting the object, based on the first designation information and the second designation information, wherein
the first designation information and the second designation information include information for designating a moving body that transports an object for each of the objects, and.
the step of controlling the plurality of moving bodies includes generating schedule information for designating, for the moving body, a timing at which the moving body transports the object, and controlling the plurality of moving bodies based on the generated schedule information.

10. The movement control system according to claim 1,
wherein the schedule information includes a schedule for a first moving body of the plurality of moving bodies, the first moving body picking up the object in the first region, moving to the relay region, dropping the object in the relay region, and moving to the first region.

11. The movement control system according to claim 1,
wherein the schedule information includes a schedule for a second moving body of the plurality of moving bodies, the second moving body moving to the relay region, picking up the object in the relay region, moving to the second region, and dropping the object in the second region.
